(19) United States
(12) Patent Application Publication
(10) Pub. No.: US 2003/0044213 A1
(43) Pub. Date: Mar. 6, 2003

(54) Multifunction keyboard accessory

(76) Inventors: James Mark Stanton, San Jose, CA (US); Chris H. Franks, Campbell, CA (US); June Lee, San Francisco, CA (US); Robert F. Mori, Palo Alto, CA (US)

Correspondence Address: B. NOEL KIVLIN, CONLEY, ROSE & TAYON, P.C., P.O. BOX 398, AUSTIN, TX, 78767-0398, US

(21) Appl. No.: 09/947,205

(22) Filed: Sep. 4, 2001

(51) Int. Cl. B41J 5/10

(52) U.S. Cl. 400/472; 400/489

(57) ABSTRACT

A multifunction keyboard accessory may be coupled to a keyboard. In an initial position, the multifunction keyboard accessory may function as a keyboard cover that inhibits unintentional activation of keys and protects the keyboard from spills and entry of other material between the keyboard keys. The multifunction keyboard accessory may be rotated from the initial position so that the keyboard accessory functions as a document holder. Alternately, the multifunction keyboard accessory may slide forward to function as a palmrest/wrist support.

### BACKGROUND

1. Field of the Invention

The present invention generally relates to peripheral computer devices. An embodiment of the invention relates to a multifunction device for a keyboard that may function as a cover, a document holder and/or a palmrest or wrist support.

2. Background of the Invention

Keyboards have been used for many years as input devices for computers. A typical keyboard includes a body with multiple keys on an upper face. The keys correspond to particular symbols or particular commands. When a user of a computer keyboard depresses a key or a combination of keys, the keyboard sends an input signal to the computer. Typically, the computer displays the symbol on a screen if the input signal corresponds to a symbol, or the computer executes a command if the input signal corresponds to a command.

A keyboard may include a body and over one hundred individual keys. Spaces may exist between the body and the keys, and between adjacent keys. Material may be spilled into the spaces of a keyboard. Also, dust and debris may collect within such spaces. Foreign matter in the spaces of a keyboard may interfere with the functioning of the keyboard. To inhibit the collection of matter within spaces of a keyboard, a user may place a keyboard cover over the keyboard.

One type of keyboard cover includes a clear, flexible material that is placed on top of the keys. This type of keyboard cover allows a user to use the keyboard even when the cover is placed on the keyboard. The cover may make the keyboard difficult to use. Such keyboard covers are typically used in environments where there is a likelihood that materials may be spilled onto the keyboard, such as in a chemical laboratory environment. Another type of keyboard cover includes a rigid or flexible cover that is placed over the keyboard when the keyboard is not in use. Such keyboard covers are typically removed and stored when the keyboard is in use. Removing, storing, and replacing a keyboard cover each day may be a nuisance and an inconvenience to a user of the keyboard.

Some keyboard users use a keyboard for extended periods of time. Use of a keyboard for long periods of time may subject the user to fatigue and strain. In some cases, the extended use of a keyboard may result in pain and injury to the user. For example, a user of a keyboard may develop carpal tunnel syndrome due to repetitive motion associated with typing. Carpal tunnel syndrome may cause severe pain and weakness to the wrist and/or hand of the keyboard user. Many keyboards and devices have been developed to help reduce such fatigue and strain to keyboard users. Some keyboards include retractable support members that allow a user to tilt the keyboard upwards. A tilted keyboard may provide easier access to the keys. Easier access to the keys may reduce user fatigue and strain. Some keyboards have an ergonomic, split keyboard design that may reduce discomfort associated with using conventional keyboards.

A keyboard may include a palm rest that provides a user with a support surface for the user's hands. A user may support the palms of the user's hands against the palmrest when the user is not typing. Also, a wrist pad may be placed in front of a keyboard. A wrist pad may provide a support for a user's arms to reduce strain transmitted to the user's wrists when the user uses a keyboard. The use of a palmrest and/or a wrist pad may help to reduce user fatigue and strain associated with the use of a keyboard.

The space within a workspace that is occupied by a keyboard and peripheral keyboard devices may be large. Peripheral keyboard devices may include, but are not limited to palmrests and/or wrist pads, and document holders. Reducing the area of a workspace occupied by a keyboard and peripheral keyboard devices may allow for more efficient use of a workspace.

A user of a keyboard may often perform data entry and/or transcription work. Data entry consists of keying information into a computer database, while transcription entails typing information from a document or audiotape into the computer. Data or a document may be positioned on a desktop surface near the keyboard. A document may also be positioned on a document holder. The document holder may be attached to a computer monitor, or the document holder may be a separate, stand-alone device. A document holder typically includes a clip or other securing device to secure the document to the document holder. Positioning a document holder in available space may result in the placement of a document in an inconvenient location.

### SUMMARY OF THE INVENTION

A multifunction keyboard accessory may be coupled to a keyboard. The keyboard accessory may function as a keyboard cover, a document holder, and/or a palmrest/wrist support. The keyboard accessory may be a separate component that is removably attached to a keyboard, or the keyboard accessory may be formed as an integral member of a keyboard.

A multifunction keyboard accessory may be slidably coupled to a keyboard. A user may slide the multifunction keyboard accessory from one position to another to change the use of the multifunction keyboard accessory. In an initial position, the multifunction keyboard accessory may be positioned over keys of the keyboard. In the initial position, the multifunction keyboard accessory may protect the keys from spills, particulate matter, dust and unintentional activation.

A user may slide a multifunction keyboard accessory relative to the keyboard from an initial position where the keyboard accessory functions as a keyboard cover to a position where the multifunction keyboard accessory functions as a palmrest. In certain embodiments a portion of the multifunction keyboard accessory may be made of a transparent material that allows a user to read documents positioned beneath the keyboard accessory when the keyboard accessory functions as a palmrest or wrist support.

A user may rotate a multifunction keyboard accessory from an initial position where the keyboard accessory functions as a keyboard cover to a position where the multifunction keyboard accessory functions as a document holder. The document holder may include a rotation stop that limits the rotational range of the keyboard accessory relative to the keyboard. The keyboard accessory may include a retainer that holds a document against the keyboard accessory. In an embodiment, a position of the retainer relative to a document is adjustable. The retainer may include a transparent or semi-transparent section that includes a position marker. The position marker may function as a location marker for a user of the document holder.

The keyboard accessory may be adjusted from an initial position where the accessory functions as a keyboard cover, or from a first position where the accessory functions as a document holder, to a second position where the accessory functions as a palmrest/wrist support.

A multifunction keyboard accessory may include pins that fit within grooves on sides of a keyboard. The pins and grooves allow the position of the multifunction keyboard accessory to be changed from one position to another. In certain embodiments, end covers may be placed on sides of a keyboard. The end covers may include grooves that allow a multifunction keyboard accessory to be slidably coupled to the keyboard. From the initial position, the pins may slide along grooves in end covers on the left and right sides of the keyboard. The multifunction keyboard accessory may slide towards the front of the keyboard (towards a user) to the second position where the accessory functions as a palmrest/writ support. In the second position, the palmrest/wrist support is positioned on the desktop surface at the front of the keyboard. In an embodiment, the palmrest/wrist support may be made of translucent (or transparent) plastic, Plexiglas®, or glass, and may be designed to retain thin media, such as printed paper, that may be viewed through the accessory during use. The multifunction keyboard accessory may be imprinted with logos or other indicia.

Also, from the initial position, the multifunction keyboard accessory may be rotated up on the pins within the grooves in the end cover on the left and right sides of the keyboard to the first position where the accessory functions as a document holder. The secondary side of any printed material (retained as stated above) may be viewed from this position. In an embodiment, articulated arms attached to the left and right sides of the keyboard may be rotated upwards to provide additional support if necessary when the accessory is being used as a document holder/display; the document holder may also include devices for securing documents, such as one or more clips.

In an embodiment, the multifunction keyboard accessory consists of two members, such that when the keyboard is in use, one of the members may be slid forward to act as a palmrest/wrist support, and the other member may be slid backward and rotated up to act as a document holder. When the keyboard is not in use, both members may be returned to an initial position to act as a keyboard cover. In one embodiment, the pins of the member that slides forward may be in front (closer to the user) of the pins of the other member. In another embodiment, there may be a lower and an upper set of two grooves in the left and the right sides of the keyboard. The pins of one member may slide along the upper set of grooves in the left and right sides of the keyboard. The pins of the other member may slide along the lower set of grooves in the left and right sides of the keyboard. The member having pins positioned in the lower grooves may be wider than the member having pins positioned in the upper grooves to allow the members to freely slide along the grooves, unobstructed by each other.

In another embodiment, instead of a keyboard comprising grooves, a multifunction keyboard accessory device comprises a grooved track. The track may be removably attached to a keyboard using adjustable clamps, such that the keyboard accessory may be attached via the clamps to a variety of different sized and shaped keyboards. One or more accessory members may be attached to the track using pins as described above. In this manner, a special keyboard with grooved tracks is not needed.

### BRIEF DESCRIPTION OF THE DRAWINGS

Advantages of the present invention will become apparent to those skilled in the art with the benefit of the following detailed description of the preferred embodiments and upon reference to the accompanying drawings in which:

FIG. 1 depicts a top elevational view of an embodiment of a multifunction keyboard accessory in a palmrest/wrist support configuration;

FIG. 2 depicts a side elevational view of an embodiment of a multifunction keyboard accessory in a palmrest/wrist support configuration;

FIG. 3 depicts a side elevational view of an embodiment of a multifunction keyboard accessory in a keyboard cover configuration;

FIG. 4 depicts a top elevational view of an embodiment of a multifunction keyboard accessory in a keyboard cover configuration;

FIG. 5 depicts a top elevational view of an embodiment of a multifunction keyboard accessory in a document holder position;

FIG. 6 depicts a side elevational view of an embodiment of a multifunction keyboard accessory in a document holder configuration;

FIG. 7 depicts a side elevational view of another embodiment of a multifunction keyboard accessory in a keyboard cover configuration;

FIG. 8 depicts a side elevational view of another embodiment of a multifunction keyboard accessory with two member in a palmrest/wrist support and document holder configuration; and

FIG. 9 depicts a side elevational view of yet another embodiment of a multifunction keyboard accessory in a palmrest/wrist support configuration.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

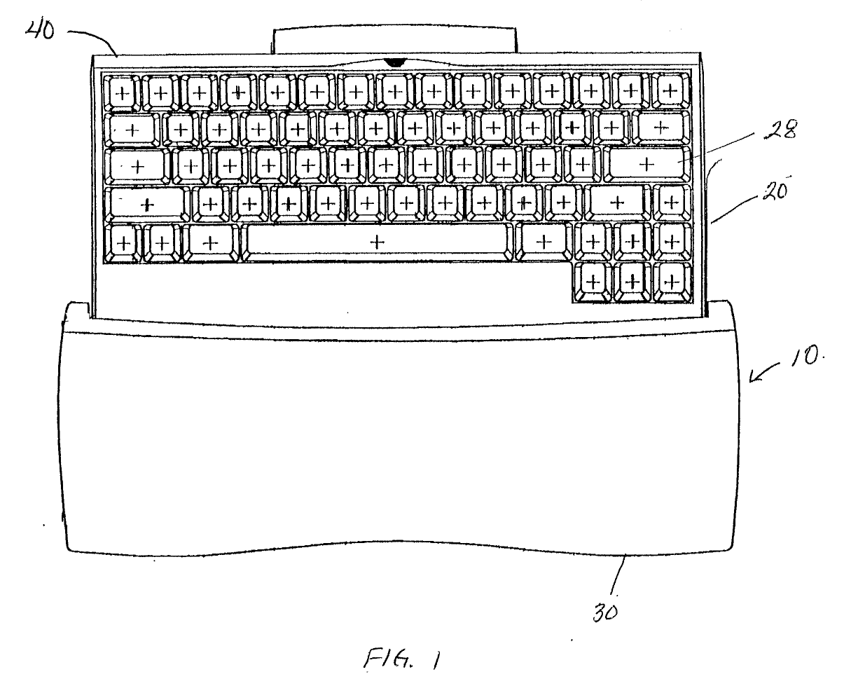

Referring to the drawings, particularly FIG. 1, a multifunction keyboard accessory is designated generally as reference 10. In the embodiments described herein, the keyboard accessory 10 may be formed as an integral member 30 of a keyboard 20. In another embodiment, the keyboard accessory 10 may be a separate member 30 that is removably attached to a keyboard 20.

FIGS. 1 and 2 show a top elevational view and a side elevational view, respectively, of an embodiment of the accessory 10 functioning as a palmrest/wrist support. A portion of member 30 may be made of a transparent material such that a user may place and read documents positioned beneath the accessory when in the palmrest/wrist support position. The member 30 may be removably attached to a keyboard 20 using pins 32 within grooves 22 on the left and right sides of the keyboard 20, as shown on the right side of the keyboard 20 depicted in FIG. 2, such that the member 30 may be slid on the pins 32 along the grooves 22 on both sides of the keyboard 20. With the member 30 positioned toward the front of keyboard 20, member 30 may function as a palmrest/wrist support. As such, the pins 32 are positioned at the front end 24 of the grooves 22 on both sides of the keyboard 20 and may rest on support members 34 which may be located on the left and right sides of member 30 as shown on the right side in FIG. 2. In an embodiment, the front ends 24 of the grooves 22 may be curved, as shown in FIG. 2, in such a way as to inhibit inadvertent sliding of the member 30 from position during use.

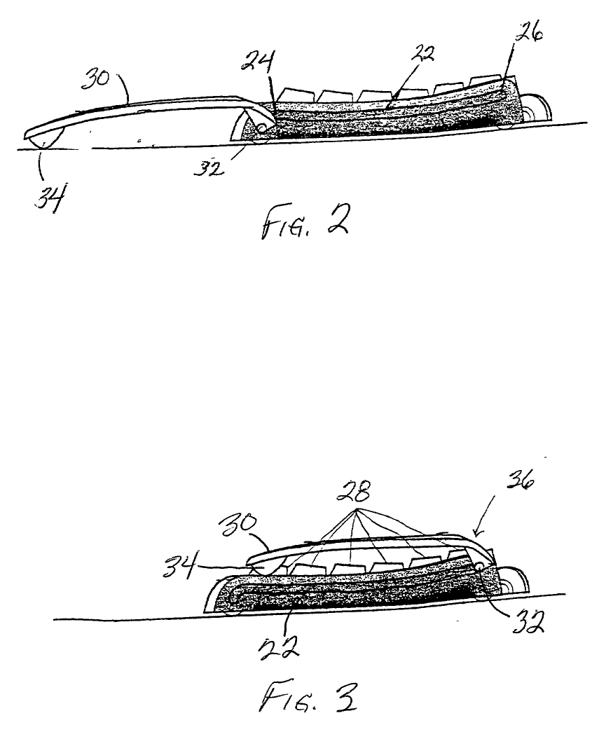

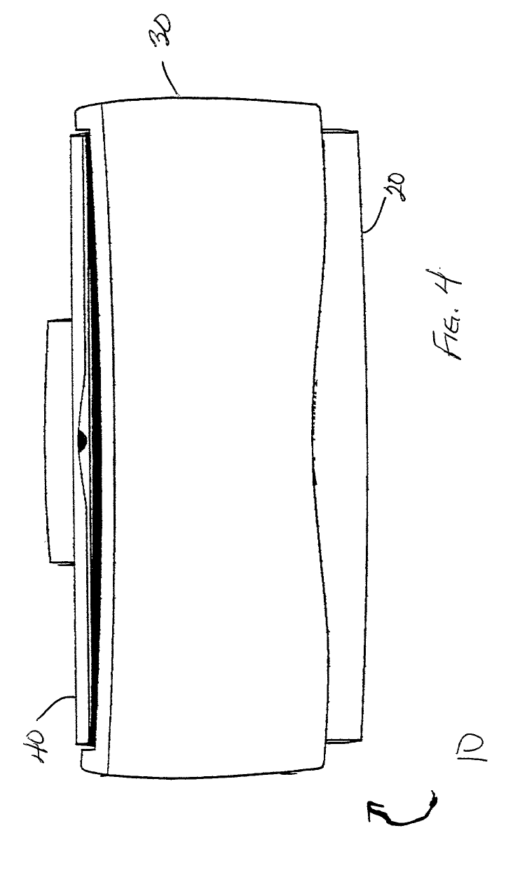

FIGS. 3 and 4 show a side elevational view and a top elevational view, respectively, of the same embodiment of the keyboard accessory 10, with the member 30 in a position to function as a cover to keyboard 20. The member 30 positioned to function as a cover to keyboard 20 may protect the keys 28 from spills, particulate matter, dust, and unintentional activation when not in use. From the member 30 in the position described for a palmrest/wrist support in FIGS. 1 and 2, the user may slide the member 30 on the pins 32 along the grooves 22 until the pins reach the back ends 26 of the grooves 22. In this position, the member 30 are support on the pins 32 within the grooved 22 and the support members 34 do not contact the keys 28 of the keyboard 20.

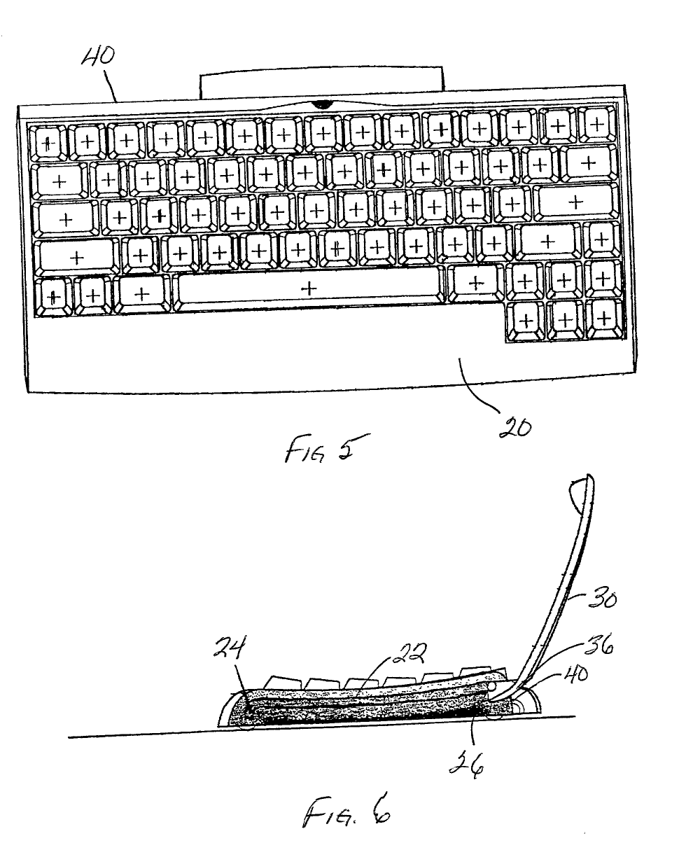

FIGS. 5 and 6 show a top elevational view and a side elevational view, respectively, of the same embodiment as shown in FIGS. 1 through 4, with the member 30 in a document holder/display position. From the member 30 in the position described for a keyboard cover in FIGS. 3 and 4, a user may rotate member 30 upward on the pins 32 until a back portion 36 of the member 30 contacts a back portion 40 of the keyboard 20 as shown in FIG. 6. The keyboard accessory 10 may also include an adjustable retainer device that holds a document against the member 30 during use. A portion of the retainer device may be made of a transparent material and may include a position marker. The keyboard accessory 10 may also include articulated arms attached to the left and right sides of the keyboard 20 to provide additional support. In an embodiment, the support members 34 may be adjustable, such that they may slide along slots in the member 30 to function as a document guide, retainer, and/or position marker with the member 30 in this position.

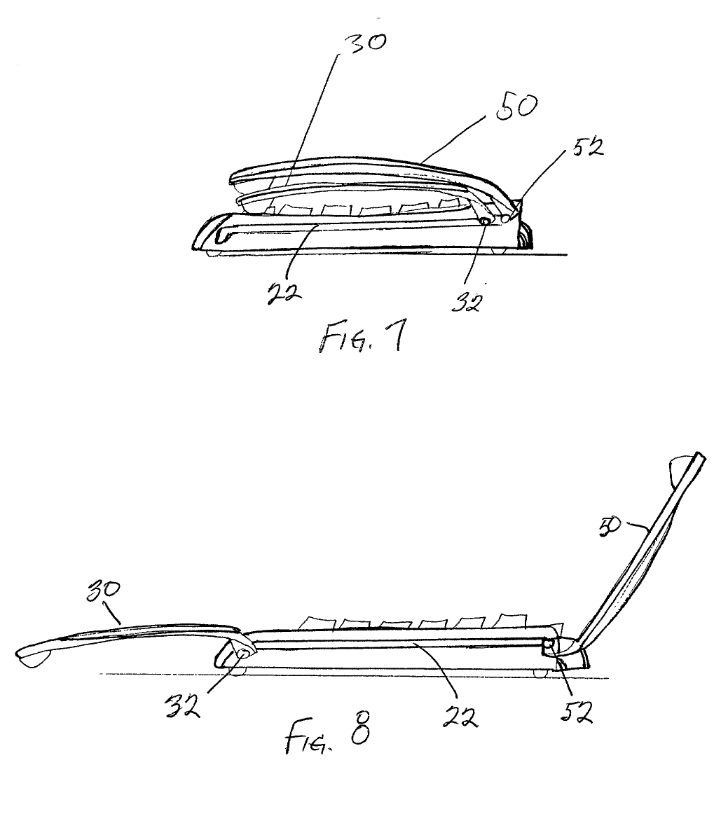

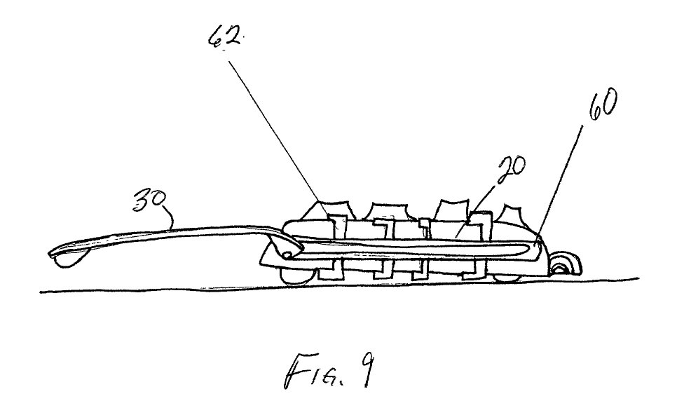

FIGS. 7 and 8 show side elevational views of another embodiment, in which the keyboard accessory 10 may include two members, 30 and 50. FIG. 7 depicts a first member 30 and a second member 50 in positions to both function as covers to keyboard 20. FIG. 8 depicts a first member 30 in a position to function as a palmrest/wrist support and a second member 50 in a position to function as a document holder/display. The second member 50, in an embodiment, may also be removably attached to the keyboard 20 with pins 52 in grooves 22 on the left and right sides of the keyboard 20, such that the second member 50 may also slide on the pins 52 along the grooves 22. The second member 50 may rest on top of the first member 30, as shown in FIG. 7, when the first member 30 and second member 50 are positioned as a cover to keyboard 20. As such, the pins 52 for the second member 50 may be closer to the back ends 26 of the grooves 22 than the pins 32 for the first member. In another embodiment, a lower and an upper set of grooves 22 may be included on the left and right sides of the keyboard 20, in which the pins 32 of the first member 30 may slide along the lower set of grooves and the pins 52 of the second member may slide along the upper set of grooves on both sides of the keyboard 20. The member 30 having pins 32 positioned in the lower set of grooves 22 may be wider than the member 50 having pins 52 positioned in the upper set of grooves 22 to allow the members 30 and 50 to freely slide along the grooves 22, unobstructed by each other.

FIG. 9 shows a side elevational view of yet another embodiment of a multifunction keyboard accessory 10. As shown in FIG. 9, the keyboard accessory 10 includes a grooved track 60 instead of the grooves 22 included on the keyboard 20. The grooved track 60 may be removably attached to a keyboard 20 using adjustable clamps 62. In this embodiment, the keyboard accessory 10 may be attached via clamps 62 to a variety of different sized and shaped keyboards. A member 30 of the keyboard accessory 10 may be attached to and use the grooved track 60 using pins 32 as described above. A second member 50 may also be attached to and use the grooved track 60 using pins 52 as described above. In this embodiment, a special keyboard 20 with grooved tracks on the left and right sides is not needed.

A user may slide and position the multifunction keyboard accessory 10 from one position to another to change the use of the multifunction keyboard accessory as needed. A portion of the members 30 and/or 50 of the accessory 10 may be made of translucent (or transparent) plastic, Plexiglas®, or glass, and may be designed to retain thin media, such as printed paper, that may be viewed through the accessory during use. The multifunction keyboard accessory 10 may be imprinted with logos or other indicia.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A keyboard assembly, comprising:
a first member comprising a first side and a second side;
a keyboard comprising a first side and a second side; and
an engager extending from the first member, the engager configured to slidably and rotatably attach the first member to the first and second sides of the keyboard; wherein the first member is configured to slide and rotate along the first and second sides of the keyboard.

2. The assembly of claim 1, wherein an initial position of the first member is positioned over a top side of the keyboard, wherein the first member is further configured to function as a cover to the keyboard.

3. The assembly of claim 1, wherein the first member is slidably and rotatably positionable in front of the keyboard, wherein the first member is further configured to function as a palmrest/wrist support during use.

4. The assembly of claim 1, wherein the first member is slidably and rotatably positionable on a back side of the keyboard, wherein the first member is further configured to function as a document holder during use.

5. The assembly of claim 1, further comprising a retainer for thin media.

6. The assembly of claim 5, wherein the retainer comprises articulated arms attached to the first and second sides of the keyboard.

7. The assembly of claim 1, wherein the keyboard further comprises grooves on the first and second sides, and wherein the engager comprises pins extending from the first and second sides of the first member, the pins configured to slidably and rotatably couple the first member to the keyboard within the grooves on the first and second sides of the keyboard.

8. The assembly of claim 7, wherein first member is slidably and rotatably positionable in front of the keyboard, and wherein a front end of the grooves are curved to prevent movement of the first member from the second position.

9. The assembly of claim 1, wherein at least a portion of the first member further comprises a transparent material.

10. The assembly of claim 1, further comprising a grooved track, wherein the grooved track is coupled to the first and second sides of the keyboard with adjustable clamps, and wherein the engager comprises pins extending from the first and second sides of the first member, the pins configured to slidably and rotatably couple the first member to the keyboard within the grooved track on the first and second sides of the keyboard.

11. The assembly of claim 1, wherein the first member further comprises support members.

12. The keyboard assembly, comprising:
a first member comprising a first side and a second side;
a second member comprising a first side and a second side;
a keyboard comprising a first side and a second side; and
an engager extending from the first and second members, the engager configured to slidably and rotatably attach the first and second members to the first and second sides of the keyboard;
wherein the first and second members are configured to slide and rotate along the first and second sides of the keyboard.

13. The assembly of claim 12, wherein an initial position of the first member and the second member is positioned over a top side of the keyboard, wherein the first and second members are further configured to function as a cover to the keyboard.

14. The assembly of claim 12, wherein the first member is slidably and rotatably positionable on a back side of the keyboard, wherein the first member is further configured to function as a document holder during use.

15. The assembly of claim 12, further comprising a retainer for thin media.

16. The assembly of claim 15, wherein the retainer comprises articulated arms attached to the first and second sides of the keyboard.

17. The assembly of claim 12, wherein the second member is slidably and rotatably positionable in front of the keyboard, wherein the second member is further configured to function as a palmrest/wrist support during use.

18. The assembly of claim 12, wherein the keyboard further comprises grooves on the first and second sides, and wherein the engager comprises pins extending from the first and second sides of the first and second members, the pins configured to slidably and rotatably couple the first and second members to the keyboard within the grooves on the first and second sides of the keyboard.

19. The assembly of claim 18, wherein the second member is slidably and rotatably positionable in front of the keyboard, and wherein a front end of the grooves are curved to prevent movement of the second member from the at least second position during use.

20. The assembly of claim 12, wherein at least a portion of the first member and second member further comprises a transparent material.

21. The assembly of claim 12, wherein the first and second members further comprise support members.

22. A keyboard assembly, comprising:
at least one member comprising a first side and a second side;
a keyboard comprising a first side and a second side; and
a means for coupling the at least one member to the keyboard;
wherein the at least one member is configured to slide and rotate along the first and the second sides of the keyboard from an initial position to a first position and a second position.

23. The assembly of claim 22, wherein an initial position of the at least one member is positioned over a top side of the keyboard, wherein the at least one member is further configured to function as a cover to the keyboard.

24. The assembly of claim 22, wherein the at least one member is slidably and rotatably positionable in front of the keyboard, wherein the at least one member is further configured to function as a palmrest/wrist support during use.

25. The assembly of claim 22, wherein the at least one member is slidably and rotatably positionable on a back side of the keyboard, wherein the at least one member is further configured to function as a document holder during use.

26. The assembly of claim 22, wherein the means for coupling the at least one member to the keyboard comprises:
at least one set of grooves on the first and second sides of the keyboard; and
pins extending from the first and second sides of the at least one member;
wherein the pins are configured to slidably and rotatably couple the at least one member to the keyboard within the at least one set of grooves on the first and second sides of the keyboard.

27. The assembly of claim 26, wherein the at least one member is slidably and rotatably positionable in front of the keyboard, and wherein a front end of the at least one set of grooves are curved to prevent movement of the at least one member from the second position during use.

28. The assembly of claim 22, wherein the means for coupling the at least one member to the keyboard comprises:
a grooved track coupled to the first and second sides of the keyboard; and
pins extending from the first and second sides of the at least one member;
wherein the grooved track is coupled to the first and second sides of the keyboard with adjustable clamps, and wherein the pins are configured to slidably and rotatably couple the at least one member to the keyboard within the grooved track on the first and second sides of the keyboard.
